(19) United States
(12) Patent Application Publication
(10) Pub. No.: US 2019/0129222 A1
(43) Pub. Date: May 2, 2019

(54) LIQUID CRYSTAL DISPLAY PANEL AND LIQUID CRYSTAL DISPLAY DEVICE FOR CURVED DISPLAY

(71) Applicant: Shenzhen China Star Optoelectronics Semiconductor Display Technology Co., Ltd., Shenzhen, Guangdong (CN)

(72) Inventor: Wu CAO, Shenzhen, Guangdong (CN)

(21) Appl. No.: 15/742,083

(22) PCT Filed: Nov. 9, 2017
(86) PCT No.: PCT/CN2017/110211

§ 371 Date: Jan. 5, 2018

(30) Foreign Application Priority Data
Oct. 26, 2017 (CN) 201711020915.9

(51) Int. Cl. G02F 1/1339; G02F 1/1333; G02F 1/1362; G02F 1/1335

(52) U.S. Cl. CPC G02F 1/13394; G02F 1/133345; G02F 1/1368; G02F 1/133512; G02F 2001/136222; G02F 1/136286

(57) ABSTRACT

A liquid crystal display panel for curved display is provided including an upper substrate, a lower substrate, and a liquid crystal layer between the two substrates. A plurality of columnar spacers extend from the lower surface of the upper substrate, a longitudinal section of the columnar spacer in one direction is an inverted trapezoid, and a top surface of the columnar spacer is smaller than a surface thereof in contact with the upper substrate; an TFT array layer is formed on the lower substrate, at least a color resist layer is formed on the TFT array layer, and an inverted trapezoidal groove is further formed on the lower substrate; the columnar spacer is accommodated in the corresponding inverted trapezoidal groove, and the top surface of the columnar spacer is in contact with the bottom surface of the trapezoidal groove. The disclosure also discloses a corresponding liquid crystal display device.

### RELATED APPLICATIONS

The present application is a National Phase of International Application Number PCT/CN2017/110211, filed Nov. 9, 2017, and claims the priority of China Application No. 201711020915.9, filed Oct. 26, 2017.

### FIELD OF THE DISCLOSURE

The disclosure relates to the field of display, and in particular to a liquid crystal display panel and a liquid crystal display device for curved display.

### BACKGROUND

The quality and overall performance of a liquid crystal display is largely affected by the material, device structure and process impact. Currently, a display panel of a liquid crystal display is formed by injecting liquid crystal material and performing a cell-aligning process between an array substrate and a color filter substrate. The alignment of the liquid crystal in the liquid crystal cell is controlled by applying a voltage to the electrodes on the array substrate and the color filter substrate to form an electric field, and the luminous flux passing through the liquid crystal cell is controlled by using the optical properties such as optical anisotropy and birefringence of the liquid crystal molecules, so as to obtain the desired graphics. Since the thickness of the liquid crystal cell formed by the array substrate and the color filter substrate directly affects the luminous flux passing through the liquid crystal cell, controlling and maintaining the thickness of the liquid crystal cell plays an extremely important role in improving the display uniformity and optimizing the display performance of the liquid crystal display.

In order to control and maintain the consistency of the thickness of the liquid crystal cell of the display panel, one of the methods in the prior art is to form the columnar spacer with a certain height on the color filter substrate. For example, as shown in FIG. 1, a post spacer (PS) layer is formed on a color filter substrate 200′ where a black matrix 201′, a color pixel layer 202′, a common electrode layer, and a liquid crystal alignment layer are formed; the PSs 102′ are formed on the color filter layer by using a mask to pattern the PS layer by the photolithographic process, and the thickness of the liquid crystal cell is controlled and maintained by the PS 102′ and the sealant 101′ located between the color filter substrate 200′ and the array substrate 100′. Since the position, height, and topography of the PS 102′ can be precisely controlled by the photolithographic process, the liquid crystal display using the PS greatly improves the display performance.

However, in some applications, for example, in the case of a curved display, when the display panel is pressed, the PS easily slides laterally due to the external pressure and changes in the thickness of the liquid crystal cell, thereby resulting in uneven display of the liquid crystal display, light leakage, and other undesirable phenomena that affect the display performance of the liquid crystal display; and damages the liquid crystal alignment layer on the surface of the substrate, resulting in abnormal display.

### SUMMARY

A technical problem to be solved by the disclosure is to provide a liquid crystal display panel and a liquid crystal display device, which can make use of the cooperation of the spacers and the grooves to prevent the slippage between the upper substrate and the lower substrate to ensure the stability of display quality.

To solve the technical problem, an aspect of an embodiment of the disclosure provides a liquid crystal display panel for curved display including an upper substrate and a lower substrate disposed opposite to each other and a liquid crystal layer disposed between the upper substrate and the lower substrate, and

a plurality of columnar spacers extends from the lower surface of the upper substrate, a vertical cross section of the columnar spacer in one direction is an inverted trapezoid, and a size of a top surface of the columnar spacer is smaller than a size of a top surface of the columnar spacer in contact with the upper substrate;

an TFT array layer is formed on the lower substrate, and at least a color resist layer is formed on the TFT array layer and an inverted trapezoidal groove is further formed on the lower substrate; and

the columnar spacers are accommodated in corresponding inverted trapezoidal grooves, and the top surfaces of the columnar spacers are in contact with the bottom surfaces of the trapezoidal grooves.

The inverted trapezoidal groove is formed on the color resist layer and located at an interface between two color resists.

A protective layer is further formed on the color resist layer, and the inverted trapezoidal groove is formed on the protective layer.

A protective layer is further formed on the color resist layer, the inverted trapezoidal groove penetrates through the protective layer and the color resist layer, and is located at an interface between two color resists.

One longitudinal section of the inverted trapezoidal groove is an inverted trapezoid.

A plane where the longitudinal section of the inverted trapezoid of the columnar spacer is located coincides or is parallel with a plane formed by a gate line when the curved liquid crystal display panel is bent.

A plane where the longitudinal section of the inverted trapezoid of the inverted trapezoidal groove is located coincides or is parallel with a plane formed by a gate line when the curved liquid crystal display panel is bent.

A top surface of the columnar spacer and a bottom surface of the inverted trapezoidal groove are the same size in the direction of the longitudinal section.

A black matrix layer is arranged between the lower surface of the upper substrate and the columnar spacers.

Accordingly, the disclosure also provides a liquid crystal display device, which includes a liquid crystal display panel including an upper substrate, a lower substrate and a liquid crystal layer in the middle of the upper substrate and the lower substrate which are arranged opposite to each other, and

a plurality of columnar spacers extends from the lower surface of the upper substrate, a vertical cross section of the columnar spacer in one direction is an inverted trapezoid, and a size of a top surface of the columnar spacer is smaller than a size of a top surface thereof in contact with the upper substrate;

an TFT array layer is formed on the lower substrate, and at least a color resist layer is formed on the TFT array layer and an inverted trapezoidal groove is further formed on the lower substrate; and

the columnar spacer is corresponding to and accommodated in an inverted trapezoidal groove, and the top surface of the columnar spacer is in contact with a bottom surface of the trapezoidal groove.

The inverted trapezoidal groove is formed on the color resist layer and located at an interface between two color resists.

A protective layer is further formed on the color resist layer, and the inverted trapezoidal groove is formed on the protective layer.

A protective layer is further formed on the color resist layer, the inverted trapezoidal groove penetrates through the protective layer and the color resist layer and is located at an interface between two color resists.

One longitudinal section of the inverted trapezoidal groove is an inverted trapezoid.

A plane where the longitudinal section of the inverted trapezoid of the columnar spacer is located coincides or is parallel with a plane formed by a gate line when the curved liquid crystal display panel is bent.

A plane where the longitudinal section of the inverted trapezoid of the inverted trapezoidal groove is located coincides or is parallel with a plane formed by a gate line when the curved liquid crystal display panel is bent.

A top surface of the columnar spacer and a bottom surface of the inverted trapezoidal groove are the same size in the longitudinal sectional direction.

A black matrix layer is arranged between the lower surface of the upper substrate and the columnar spacers.

The embodiment of the has the following advantageous effects:

The liquid crystal display panel provided by the disclosure utilizes the spacer with an inverse trapezoid in longitudinal section extended downwards from the upper substrate of the liquid crystal display panel and an inverted trapezoidal groove arranged on the color resist layer and/or the protective layer of the upper substrate. The spacer cooperates with the inverted trapezoidal groove so that the inverted trapezoidal groove can buckle the inverted trapezoidal spacer in the gate line direction of the liquid crystal display panel, and the movement of the spacer can be prevented, the slippage between the upper substrate and the lower substrate in the gate line direction can be prevented; and the stability of the display quality can be ensured; simultaneously, the disclosure limits the size of the spacer and the inverted trapezoidal groove only in the gate line direction, and may not be limited in the other direction, so as to reduce the difficulty of aligning the upper substrate and the lower substrate.

### BRIEF DESCRIPTION OF THE DRAWINGS

In order to illustrate technical schemes of the disclosure or the prior art more clearly, the following section briefly introduces drawings used to describe the embodiments and prior art. Obviously, the drawing in the following descriptions is just some embodiments of the disclosure. The ordinary person in the related art can acquire the other drawings according to these drawings without offering creative effort.

FIG. 1 is a schematic view of the structure of a display panel in the prior art;

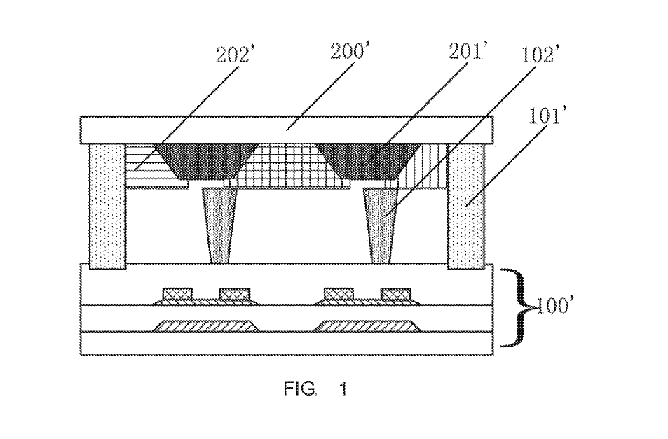

FIG. 2 is a schematic view of the external structure of a liquid crystal display panel for curved surface display according to the disclosure;

FIG. 3 is a schematic structural view of an embodiment of a liquid crystal display panel for curved display according to the disclosure;

FIG. 4 is a schematic front view of a structure of an embodiment of a color resist layer in FIG. 3;

FIG. 5 is a schematic structural view of another embodiment of a liquid crystal display panel for curved display according to the disclosure;

FIG. 6 is a structural schematic view of a liquid crystal display panel for curved display according to a further embodiment according to the disclosure; and

FIG. 7 is a schematic front view of a structure of an embodiment of a color resist layer in FIG. 6.

### DETAILED DESCRIPTION OF PREFERRED EMBODIMENTS

The following sections offer a clear, complete description of the in combination with the embodiments and accompanying drawings. Obviously, the embodiments described herein are only a part of, but not all of the embodiments of the disclosure. In view of the embodiments described herein, any other embodiment obtained by those of ordinary skill in the art skilled in this art without offering creative effort is included in a scope claimed by the disclosure.

Here, it should be further noted that in order to prevent the disclosure to be obscured due to unnecessary details, only apparatus structures and/or processing steps closely related to the solution according to the disclosure are shown in the accompanying drawings, while other details having little relations are omitted.

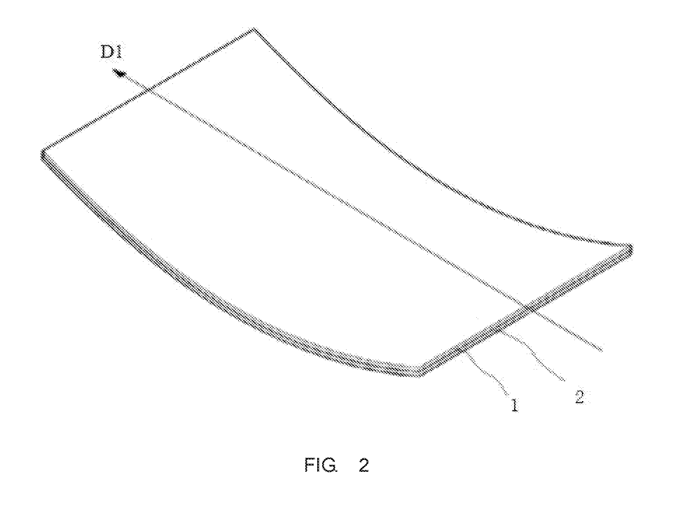

As shown in FIG. 2, which is a schematic structural diagram of the external structure of liquid crystal panel of the disclosure provides a method for displaying a display surface. In an embodiment of the disclosure, the liquid crystal display panel is applied to a curved liquid crystal display panel, and the liquid crystal display panel includes at least an upper substrate 1 and a lower substrate 2, and a liquid crystal layer disposed between the upper substrate 1 and the lower substrate 2. Here, the bending direction of the liquid crystal display panel is D1, and because each of the gate lines of the liquid crystal display panel are bent, each of the gate lines thereof are all in one plane.

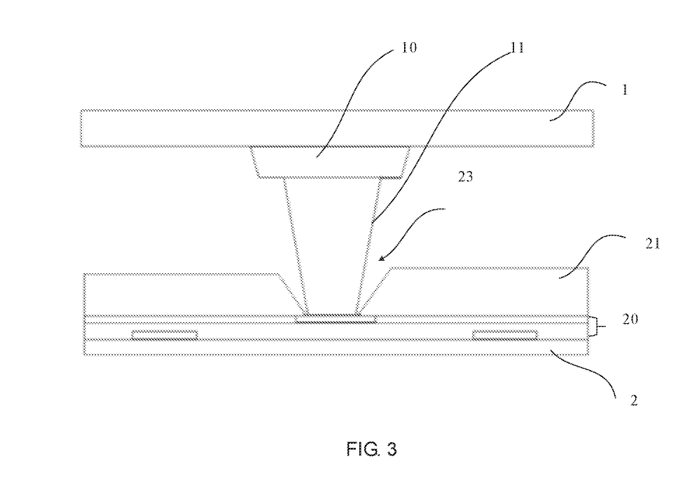

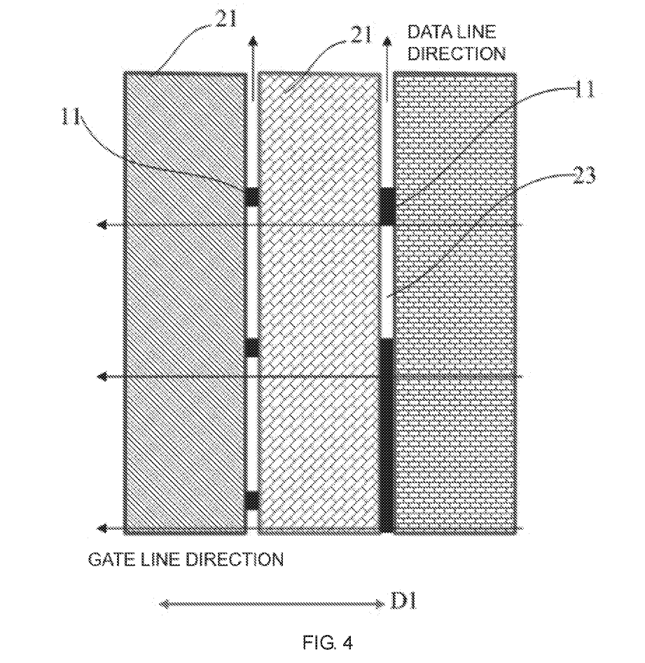

As shown in FIG. 3, a schematic structural view of an embodiment of a liquid crystal display panel provided by the disclosure is shown. As shown in conjunction with FIG. 4, in the embodiment, the liquid crystal display panel includes an upper substrate 1 and a lower substrate 2 disposed opposite to each other and a liquid crystal layer disposed between the upper substrate and the lower substrate, and

a plurality of columnar spacers 11 extend from the lower surface of the upper substrate 1, a longitudinal section of the columnar spacer 11 in a direction is an inverted trapezoid, and a size of a top surface thereof is smaller than a size of a surface thereof in contact with the upper substrate 1; it can be understood that a plane where the longitudinal section of the inverted trapezoid of the columnar spacer 11 is located coincides or is parallel with a plane formed by one of the gate lines when the curved liquid crystal display panel is bent.

An TFT array layer 20 is formed on the lower substrate 2, at least a color resist layer 21 is formed on the TFT array layer 20, an inverted trapezoidal groove 23 is further formed on the lower substrate 2; and

the columnar spacer 11 is accommodated in the corresponding inverted trapezoidal groove 23, and the top surface of the columnar spacer 11 is in contact with the bottom surface of the trapezoidal groove 23.

Specifically, the inverted trapezoidal groove 23 is formed on the color resist layer 21 and located at an interface between two color resists.

It can be understood that, in the embodiment, the plane where the longitudinal section of the inverted trapezoid of the inverted trapezoidal groove 23 is located coincides or is parallel with a plane formed by a gate line when the curved liquid crystal display panel is bent.

The top surface of the columnar spacer 11 and a bottom surface of the inverted trapezoidal groove 23 are the same size in the longitudinal sectional direction while the size of the inverted trapezoidal groove 23 and the columnar spacer 11 is not limited in the other direction perpendicular to the longitudinal section. As shown in FIG. 4, an inverted trapezoidal groove 23 is provided in the region of the interface of the two kinds of color resists. The longitudinal section in the direction along the gate line (the GATE LINE in the figure) is an inverted trapezoid. In the other direction, the data line (the DATA LINE in the figure) direction can be a line shape; here, the black area is a positioning region of the column spacer 11, from which it can be seen that the column spacer 11 can be dot-shaped structure (the shape of the spacer as shown in the left side of FIG. 4) or a long strip shape structure (the shape of the spacer as shown in the right side of FIG. 4). It can be understood that the spacers of various structures are shown in FIG. 4, and one of the spacers is often used in practice. Meanwhile, by using the structure, the columnar spacer 11 is extended into the inverted trapezoidal groove 23, the limitation of the columnar spacer 11 in the D1 direction can be ensured, the slippage between the upper substrate and the lower substrate in the D1 direction can be prevented, and the stability of the display quality can be ensured when the display is bent along D1 direction.

In addition, a black matrix layer 10 is further provided between the lower surface of the upper substrate 1 and the columnar spacers 11. It can be understood that, in some examples, the black matrix layer 10 and the columnar spacer 11 can be respectively fabricated by a separate process; in other examples, the black matrix layer 10 and the columnar spacers 11 are fabricated by one exposure and development using materials such as BPS (acrylic polymer), that is, the black matrix layer 10 and the columnar spacers 11 are integrally formed.

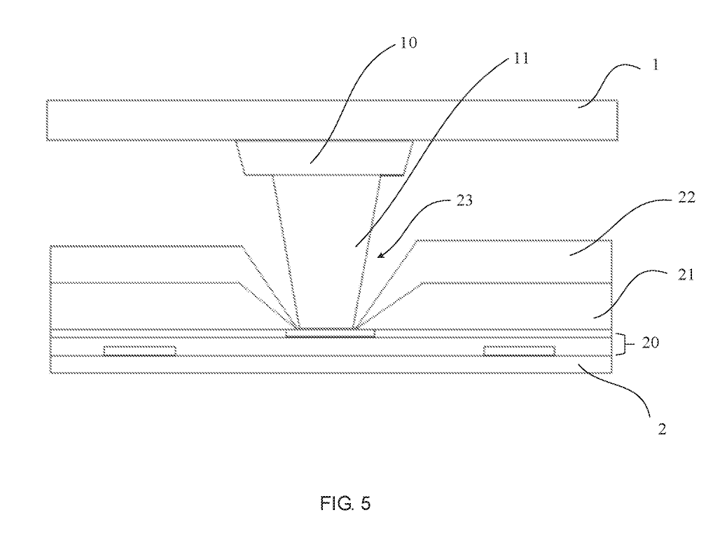

As shown in FIG. 5, a schematic structural view of another embodiment of a liquid crystal display panel provided by the disclosure is shown. As seen in this figure, the difference from the structure shown in FIG. 3 is that a protective layer 22 is further formed on the color resist layer 21. It can be understood that the protective layer 22 can be made of metal such as inorganic SiNx, Organic PFA and other materials, which can be a layer structure, it can be multi-layer structure. It can be understood that the protective layer 22 can be made of material such as inorganic SiNx and organic PFA, which can be single layer structure or a multi-layer structure. The inverted trapezoidal groove 23 penetrates through the protective layer 22 and the color resist layer 21 (that is, the protective layer 22 and the color resist layer 21 are dug to form a groove), and is located between the interface regions of the two kinds of color resists, (e.g. arranged on the data line). The other structures are similar to those shown in FIG. 3, and will not be described herein.

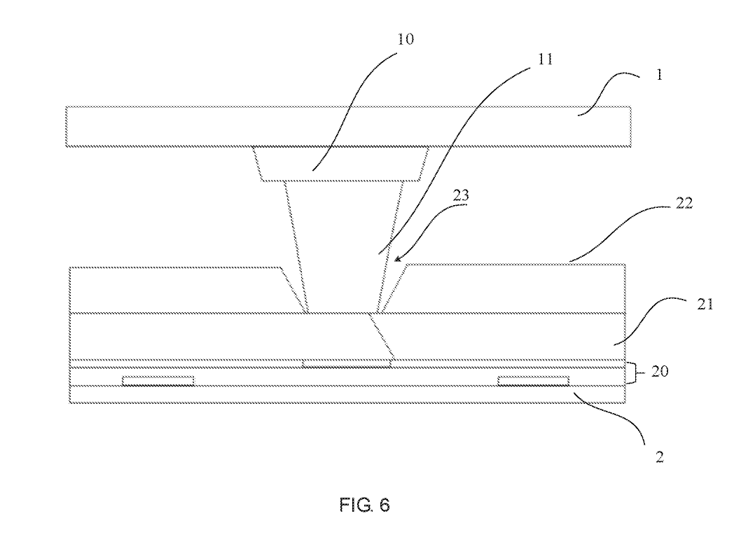

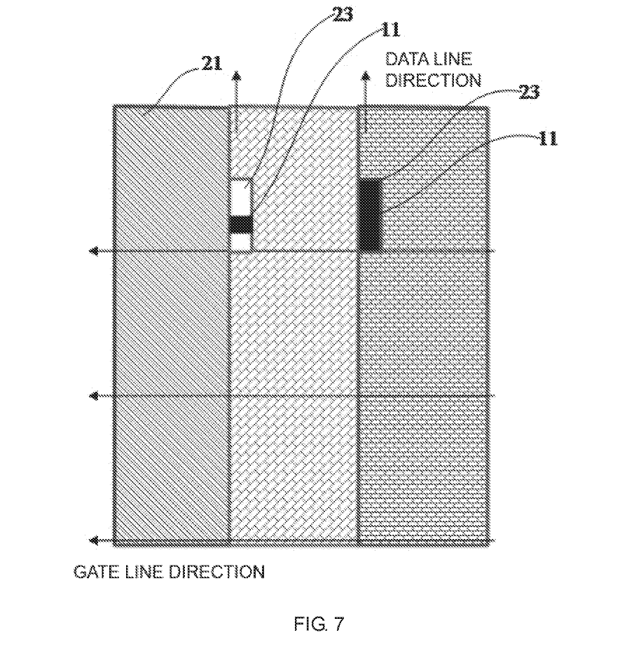

As shown in FIG. 6, a schematic structural view of still another embodiment of a liquid crystal display panel provided by the disclosure is shown. As seen in this figure, the difference from the structure shown in FIG. 7 is that a protective layer 22 is further formed on the color resist layer 21, the color resist layer 21 is of a connecting design, and the inverted trapezoidal groove 23 is formed on the protective layer 22 (that is, the protective layer 22 is dug to form a groove). The other structures are similar to those shown in FIG. 3, and will not be described herein.

Correspondingly, the disclosure further provides a liquid crystal display device, which includes the liquid crystal display panel shown in FIGS. 2 to 7.

The embodiment of the disclosure has the following advantageous effects:

The liquid crystal display panel provided by the disclosure utilizes the spacer with an inverse trapezoid in longitudinal section extended downwards from the upper substrate of the liquid crystal display panel and an inverted trapezoidal groove arranged on the color resist layer and/or the protective layer of the upper substrate. The spacer cooperates with the inverted trapezoidal groove so that the inverted trapezoidal groove can buckle the inverted trapezoidal spacer in the gate line direction of the liquid crystal display panel, and the movement of the spacer can be prevented, the slippage between the upper substrate and the lower substrate in the gate line direction can be prevented, and the stability of the display quality can be ensured; simultaneously, the disclosure limits the size of the spacer and the inverted trapezoidal groove only in the gate line direction, and may not be limited in the other direction, so as to reduce the difficulty of aligning the upper substrate and the lower substrate.

It is to be noted that, in the context, relational terms such as first and second are used only to distinguish an entity or an operation from another entity or another operation without necessarily requiring or implying that such entities or operations have any such actual relationship or sequence. Moreover, terms “include”, “comprise” or any other variant thereof is intended to encompass a non-exclusive inclusion such that processes, methods, articles, or devices that include a series of elements include not only those elements but also those that are not explicitly listed. In the absence of more restrictions, the elements defined by the statement “including a . . . ” do not preclude the presence of additional elements in the process, method, article, or device that includes the elements.

It should be indicated that the present application can also be improved and modified by those skilled in the art without departing from the principle of the present application, and these improvements and modifications also fall within the protection scope of the claims of the present application.

What is claimed is:

1. A liquid crystal display panel for curved display, comprising:
an upper substrate;
a lower substrate, disposed opposite to the upper substrate; and
a liquid crystal layer, disposed between the upper substrate and the lower substrate;
wherein a plurality of columnar spacers extends from a lower surface of the upper substrate, a longitudinal section of the columnar spacer in a direction is an inverted trapezoid, and a size of a top surface of the columnar spacer is smaller than a size of a surface of the columnar spacer in contact with the upper substrate;
wherein an TFT array layer is formed on the lower substrate, and at least a color resist layer is formed on the TFT array layer and an inverted trapezoidal groove is further formed on the lower substrate;
wherein the columnar spacer is corresponding to and accommodated in the inverted trapezoidal groove, and the top surface of the columnar spacer is in contact with a bottom surface of the inverted trapezoidal groove.

2. The liquid crystal display panel according to claim 1, wherein the inverted trapezoidal groove is formed on the color resist layer and located at an interface between two color resists.

3. The liquid crystal display panel according to claim 1, wherein a protective layer is further formed on the color resist layer, and the inverted trapezoidal groove is formed on the protective layer.

4. The liquid crystal display panel according to claim 1, wherein a protective layer is further formed on the color resist layer, the inverted trapezoidal groove penetrates through the protective layer and the color resist layer and is located at an interface between two color resists.

5. The liquid crystal display panel according to claim 1, wherein a longitudinal section of the inverted trapezoidal groove is an inverted trapezoid.

6. The liquid crystal display panel according to claim 5, wherein a plane where the longitudinal section of the columnar spacer is located coincides or is parallel with a plane formed by a gate line when the curved liquid crystal display panel is bent.

7. The liquid crystal display panel according to claim 6, wherein a plane where the longitudinal section of the inverted trapezoidal groove is located coincides or is parallel with a plane formed by a gate line when the curved liquid crystal display panel is bent.

8. The liquid crystal display panel according to claim 7, wherein a top surface of the columnar spacer and a bottom surface of the inverted trapezoidal groove are the same size in a direction of the longitudinal section.

9. The liquid crystal display panel according to claim 8, wherein a black matrix layer is arranged between the lower surface of the upper substrate and the columnar spacers.

10. A liquid crystal display device, comprising:
a liquid crystal display panel comprising an upper substrate, a lower substrate disposed opposite to the upper substrate, and a liquid crystal layer disposed between the upper substrate and the lower substrate,
wherein a plurality of columnar spacers extends from a lower surface of the upper substrate, a longitudinal section of the columnar spacer in a direction is an inverted trapezoid, and a size of a top surface of the columnar spacer is smaller than a size of a surface thereof in contact with the upper substrate;
wherein an TFT array layer is formed on the lower substrate, and at least a color resist layer is formed on the TFT array layer and an inverted trapezoidal groove is further formed on the lower substrate;
wherein the columnar spacer is corresponding to and accommodated in the inverted trapezoidal groove, and the top surface of the columnar spacer is in contact with a bottom surface of the trapezoidal groove.

11. The liquid crystal display device according to claim 10, wherein the inverted trapezoidal groove is formed on the color resist layer and located at an interface between two color resists.

12. The liquid crystal display device according to claim 10, wherein a protective layer is further formed on the color resist layer, and the inverted trapezoidal groove is formed on the protective layer.

13. The liquid crystal display device according to claim 10, wherein a protective layer is further formed on the color resist layer, the inverted trapezoidal groove penetrates through the protective layer and the color resist layer, and is located at an interface between two color resists.

14. The liquid crystal display device according to claim 10, wherein one of the longitudinal section of the inverted trapezoidal groove is an inverted trapezoid.

15. The liquid crystal display device according to claim 10, wherein a plane where the longitudinal section of the columnar spacer is located coincides or is parallel with a plane formed by a gate line when the curved liquid crystal display panel is bent.

16. The liquid crystal display device according to claim 15, wherein a plane where the longitudinal section of the inverted trapezoid of the inverted trapezoidal groove is located coincides or is parallel with a plane formed by a gate line when the curved liquid crystal display panel is bent.

17. The liquid crystal display device of claim 16, wherein a top surface of the columnar spacer and a bottom surface of the inverted trapezoidal groove are the same size in a direction of the longitudinal section.

18. The liquid crystal display device according to claim 17, wherein a black matrix layer is arranged between the lower surface of the upper substrate and the columnar spacers.
